(19) United States
(12) Patent Application Publication
(10) Pub. No.: US 2009/0308713 A1
(43) Pub. Date: Dec. 17, 2009

(54) DIVERTER

(75) Inventor: Rudolf Infanger, Hinwil (CH)

Correspondence Address: RANKIN, HILL & CLARK LLP, 38210 Glenn Avenue, WILLOUGHBY, OH, 44094-7808, US

(73) Assignee: FERAG AG, Hinwil (CH)

(21) Appl. No.: 12/516,096

(22) PCT Filed: Nov. 20, 2007
(86) PCT No.: PCT/CH2007/000580

§ 371 Date: Jun. 29, 2009

(30) Foreign Application Priority Data
Nov. 23, 2006 (CH) 1888/06

(51) Int. Cl. B65G 47/76; B65G 47/00; B65G 17/30

(52) U.S. Cl. 198/367; 198/680

(57) ABSTRACT

A diverter (1) for the selective connection of three guide means for the guided movement of at least one object (50) includes a first, a second and a third guide-means section (10, 20, 30) having in each case at least one guide surface (12, 13, 22, 23, 32, 33), and an actuating means (40) which can assume at least two positions. The actuating means (40) includes at least one actuating element (42, 42′) which can be moved between a first position and a second position perpendicularly with respect to the transport plane (T) which is defined by the guide-means sections (10, 20, 30). In the first position, an at least largely uninterrupted connection exists between at least one guide surface (12, 13, 22, 23) of the first and second guide-means sections (10, 20, 30). In the second position, in an analogous manner, an at least largely uninterrupted connection exists between at least one guide surface (12, 13, 32, 33) of the first and third guide-means sections (10, 20, 30).

### BACKGROUND OF THE INVENTION

1. Field of the Invention

The invention lies in the field of conveyor technology, and relates to a diverter for the selective connection of three guides for the guided movement of a control element or a runner roller of a conveyor unit, to conveyor systems with such a diverter, as well to an assembly for creating such a diverter.

2. Description of Related Art

Diverters or switches for the selective connection of three or more guides and thus for creating branching within a path system, are known per se, above all with rail-guided transport means such as a railway for example.

Known diverters comprise three or more guide sections which are designed for connection in each case to one guide or are formed with such as one piece. The guide sections define a plane at least locally, which hereinafter is called a transport plane, and with rail-guided transport means regularly runs in a horizontal manner. The guide sections in each case have at least one guide surface. With a guide rail, often two limitation surfaces which run parallel and are perpendicular on the transport plane, serve as guide surfaces. In a selective manner, an essentially continuous connection of the guide surfaces of the first and second or the first and third guide section is created by way of a movable actuation element. With known diverters, the actuation element, the diverter tongue, is pivotable about an axis running perpendicularly to the transport plane, i.e. moves in or parallel to the transport plane, in order to create the desired connections. As a rule, only the weight force acting perpendicularly to the mostly horizontally running transport plane is exerted onto the actuation element, which does not lead to an undesired displacement of the actuation element.

In the field of conveyor technology, in particular in the context of conveying individual objects or ones grouped in groups, e.g. printer's products, by way of conveyor units such as grippers, pockets, support elements and likewise, until now, it was above all unbranched conveyer paths which were employed. Only in more recent times has the idea of individually moving and/or individually controlling conveyor units instead of together, become widespread, so that the requirement for suitable diverters for such conveyor systems is, increasing. In particular, there exists the requirement, not only to realise branching in the conveyor path but also branching in a control cam. Thereby, known diverters with a diverter tongue movable in the transport plane may only be employed whilst accepting certain disadvantages.

This is because a displacement mechanism, with a movement of the actuation element in the transport plane, is particularly disadvantageous with conveyor units with guided control elements or runner rollers when, by way of the element to be guided, a force is exerted in the movement direction of the actuation element, i.e. transversely to the conveyor direction of the object, but parallel to the transport plane. This is because the position of the actuation element must also be stable under the influence of this force, in order to prevent an undesired displacement. This is particularly the case with the mentioned conveyor units with a vertical transport plane, since the weight force would act in the displacement direction with the use of conventional diverters. Moreover, the use of conventional diverters with control cams for guiding control elements is problematic, since these as a rule are biased in the direction of the guide surface and thus would exert a force onto this in the displacement direction independently of the orientation of the transport plane.

It is therefore the object of the invention to provide a diverter, a conveyor system and an assembly for the construction of such a diverter, which avoid the mentioned disadvantages and have a stable displacement mechanism.

### BRIEF SUMMARY OF THE INVENTION

The object is achieved by a diverter with the features of the independent claim(s), by conveyor systems with the features of the independent claim(s), as well as by an assembly. Advantageous further formations of the invention are represented in the dependent claims, the description and the drawings.

The diverter according to the invention is conceived for the application in a conveyor system with a plurality of conveyor units. The conveyor units, in particular grippers, pockets, support elements and likewise, have at least one runner roller and/or at least one control element, which at least in regions is/are guided by a guide, in particular a runner rail or a control cam. A spatial branching of the conveyor path may be realised within the system of runner rails by way of an inventive diverter. With a conveyor path remaining the same, different functions of the conveyor units, e.g. selective opening, closure or pivoting of a gripper, may be realised within the control cam by way of a diverter according to the invention.

According to the invention, an actuation member with at least one actuation element is present, which is movable essentially perpendicularly to the transport plane. The displacement, essentially perpendicular to the transport plane, has the advantage that the displacement element in principle may be stabilised over its complete extension in the direction of the transport plane, e.g. by way of guide rods or support surfaces running perpendicularly to the transport plane. Essentially perpendicular to the transport plane is also to be understood as those movements which, compared to the movement component perpendicular to the transport plane, have a movement component in the transport plane which is to be seen as being small, e.g. a pivot movement out of the position tilted out of the transport plane into the transport plane. Moreover, this also includes the case with which the transport plane is arcuate. With respect to the guide surface of the displacement element, the movement of the displacement element is effected perpendicularly to the surface normal of the guide surface.

In contrast to the invention, only a stabilisation in the region of the pivot axis is possible with conventionally pivotable diverter tongues. The displacement element may furthermore also be designed in a solid instead of two-dimensional manner, and in particular may join into the guide section in a precisely fitting manner in a direction perpendicular to the transport plane, by which means an additional stabilisation is achieved.

If only one actuation element is provided, the guide sections are shaped such that even without an actuation element, at least one guide surface of the first guide section merges into a guide surface of the second guide section, which is assigned to it, but is distanced to a guide surface of the third guide section, which is assigned to it, whilst forming a gap. The actuation element may be introduced between the guide surfaces of the first and third guide sections, which are assigned to one another, in a manner such that an at least largely uninterrupted connection between the guide surfaces of the first and third guide sections is created, and the continuous guide surface of the first and second guide sections is blocked (active position). By way of a suitably shaped actuation element guide surface which connects to the guide surfaces in a flush manner, the actuation element bridges the gap and deflects an object guided along the first guide section, to the third guide section, and vice versa. By way of a movement essentially perpendicular to the transport plane, the actuation element goes from the active position into an inactive position, in which it no longer comes into contact with the object to be guided, and releases the connection between the first and the second guide section.

If two actuation elements are present, a gap may also be located between the first and the second guide section. It may be selectively bridged or left open by way of the second actuation element.

In principle, it is possible for the diverter to only be applied for realising branching with guides which guide on one side. This is the case, for example, with control cams with control elements biased in one direction. These control elements then only need to be guided in this direction, and a single actuation element in principle is sufficient, inasmuch as only one gap and already a continuous connection between the first and the second guide section exists.

With guides guiding on two sides, e.g. rails, with two guide surfaces which stand perpendicularly on the transport plane, one employs an actuation member with two actuation elements. The actuation elements are in each case in the position of creating an at least largely interrupted connection between the two guide surfaces of the first and the second or the first and the third guide section, inasmuch as this does not already exist. Preferably, an active or passive alternating drive is present, which, by way of an opposite movement of the actuation elements, ensures that one of the actuation elements is always, in the active position.

If one is to divide up into more than two guides or one leads together from these, then correspondingly more actuation elements are applied.

The diverter comprises preferably a mechanism for self-activation of the switching procedure. This is particularly of interest when objects guided in the second and the third guide sections are to be led together into the first guide section. The self-activating mechanism, for example, functions in a passive manner by way of the objects running onto a switch lever in the guide section or on the actuation element itself and thereby producing the necessary switch force. Alternatively, the activation of an active drive on account of a sensor signal is also possible.

The application of the diverter within the framework of a conveyor system with conveyor units, in particular grippers, pockets, support elements, which are movable along a transport path, is particularly advantageous. By way of the diverter, a branched conveyor path may be constructed, in order to divide up a flow of conveyor units, to lead it together or to lead it along to one of several alternative path sections. Alternatively or additionally, it is possible with a locally unbranched conveyor path to selectively activate or deactivate individual functions of the conveyor units by way of a suitably branched control cam as guides.

An assembly for creating a diverter comprises at least one, preferably two actuation elements, as well as a drive for movement of the actuation element, and may be combined with existing guide sections, in order to construct a diverter according to the invention. The at least one actuation element has a guide surface, which is movable by the drive normally to its surface normal. This direction, in the installed condition, corresponds to a movement essentially perpendicular to the transport plane.

### BRIEF DESCRIPTION OF THE DRAWINGS

Examples of the invention are represented in the drawings. In a purely schematic manner, there are shown in:

FIG. 1a+b a basic sketch of a diverter according to the invention, with guides guiding on one side and with an actuation element in two different positions, in a view onto the transport plane;

FIG. 1c+d the diverter from FIG. 1a+b, in a view parallel to the transport plane;

FIG. 2a+b a basic sketch of a diverter according to the invention, with guides guiding on one side and with two actuation elements in two different positions;

FIG. 3 a basic sketch of a diverter according to the invention, with guides guiding on two sides and with two actuation elements;

FIG. 4a-d possible profile shapes for the guide sections;

FIG. 5+6 three-dimensional representations of a diverter according to the invention;

FIG. 7 an actuation member with two actuation elements in a three-dimensional representation with an active drive for the actuation elements;

FIG. 8 the actuation elements from FIG. 7, in a view onto the transport plane;

FIG. 9 an actuation member with two actuation elements in a three-dimensional representation with a passive switch-over mechanism for the actuation elements;

FIG. 10 a conveyor system with a branched conveyor path which has a diverter according to the invention;

FIG. 11a+b a conveyor system with an unbranched conveyor path and with a switchable control cam, which comprises a diverter according to the invention.

### DETAILED DESCRIPTION OF THE INVENTION

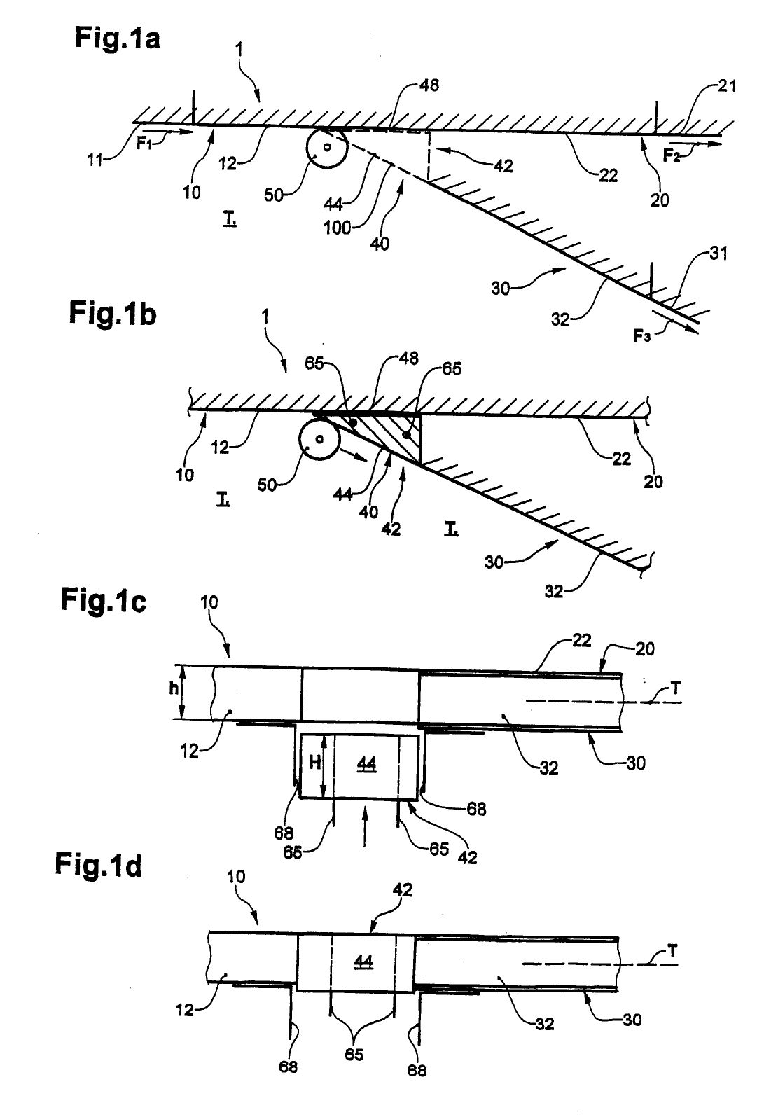

The diverter 1 shown in FIG. 1a-d comprises three guide sections 10, 20, 30, which in each case are connected to first, second and third guides 11, 21, 31 respectively. The guide sections 10, 20, 30 in each case have only one guide surface 12, 22, 32, along which an object 50, e.g. a runner roller or a control element, may be moved. It is typically the case of a control cam with a control element in the form of a control roller, which is biased against the guide surfaces 12, 22, 32. The three guide sections 10, 20, 30 define a transport plane T for the object 50, which here corresponds to the representation plane or to a plane parallel thereto. In practice, the guide sections 10, 20, 30 may be bent out of the representation plane. For the sake of simplicity, one assumes that such a three-dimensional transport surface may also locally approximate a plane. The guide surfaces 12, 22, 32 as a rule are orientated perpendicularly to the transport plane T. It is not necessary for the guide surfaces 12, 22, 32 to be plane (see FIG. 4a+b).

A first and a second guide section 10, 20 and the respective guide surfaces 12, 22 merge directly into one another. On the other hand, seen in the conveyor direction F1, a gap 100 is between the first and the second guide section 10, 30. An actuation member 40 comprises an actuation element 42, which by way of a suitable drive (not shown here), may be brought into this gap 100 in a direction perpendicular to the transport plane T, in a manner such that a largely uninterrupted, continuous connection between the first and the third guide section 10, 30 is created. For this, it has a side wall which acts as an actuation element guide surface 44 and which connects the guide surfaces 12, 32 of the first and third guide section 10, 30 to one another and thereby blocks the uninterrupted connection between the first and the second guide section 10, 20.

FIG. 1a shows a first position of the actuation member 40, which is represented in a dashed manner, in which the actuation element 42 is located above or below the transport plane T to such an extent, that the object 50 below or above the actuation element 42 is moved along the guide surfaces 12, 22 of the first guide section 10 into a first conveyor direction F1, and without transition along the second guide section 10, 20 into a second conveyor direction F2, to the second guides 21, without coming into contact with the actuation element 42. This position corresponds to the lateral view FIG. 1c. FIG. 1b shows a second position of the actuation member 40, in which the actuation element 42 is located in the transport plane T (represented hatched), so that the object 50 is moved along the guide surfaces 12, 32 of the first and third guide section 10, 30, as well as along the actuation element guide surface 44 into a third conveyor direction F3 to the third guide 31.

Preferably, the actuation element guide surface 44 perpendicular to the transport plane T has a height H which is equal or larger than the height h of the guide surfaces 12, 22, 32. The actuation element 42 on switching preferably carries out a travel corresponding to the height h of the guide surfaces 12, 22, 32.

In the represented operational manner, the diverter 1 serves for selectively deflecting an object 50 out of a direction F1 into a direction F2 or F3. A flow of several objects 50 may also be divided onto the second and third guide section 20, 30. The diverter may moreover be operated with the reverse conveying directions. In this case, objects 50 coming from the second and third guides may lead together into a common conveyor flow, onto the guide 11.

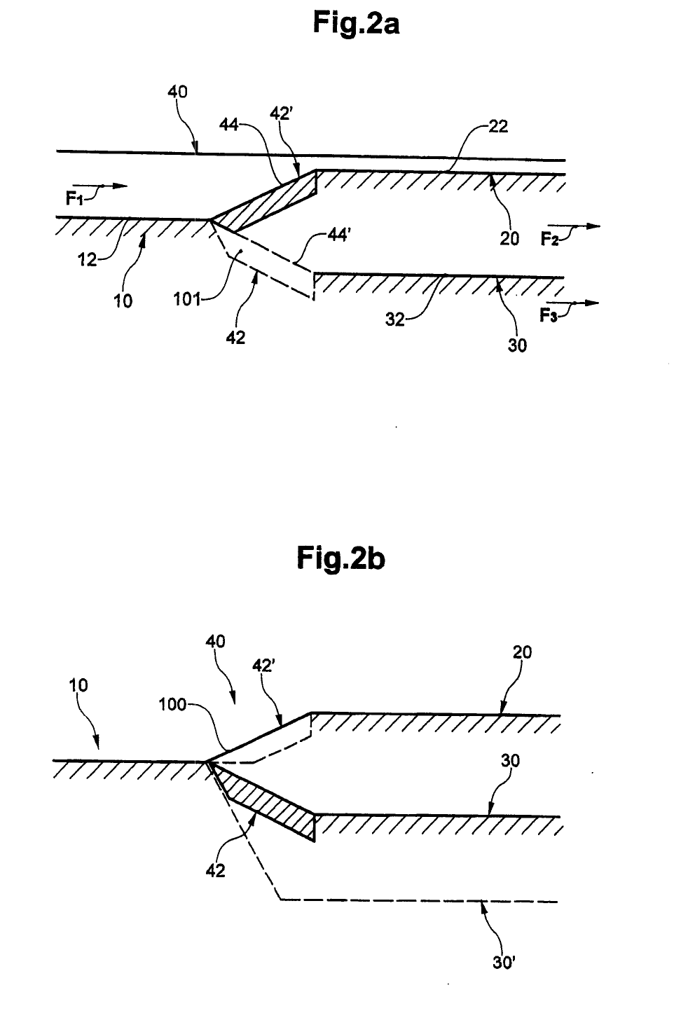

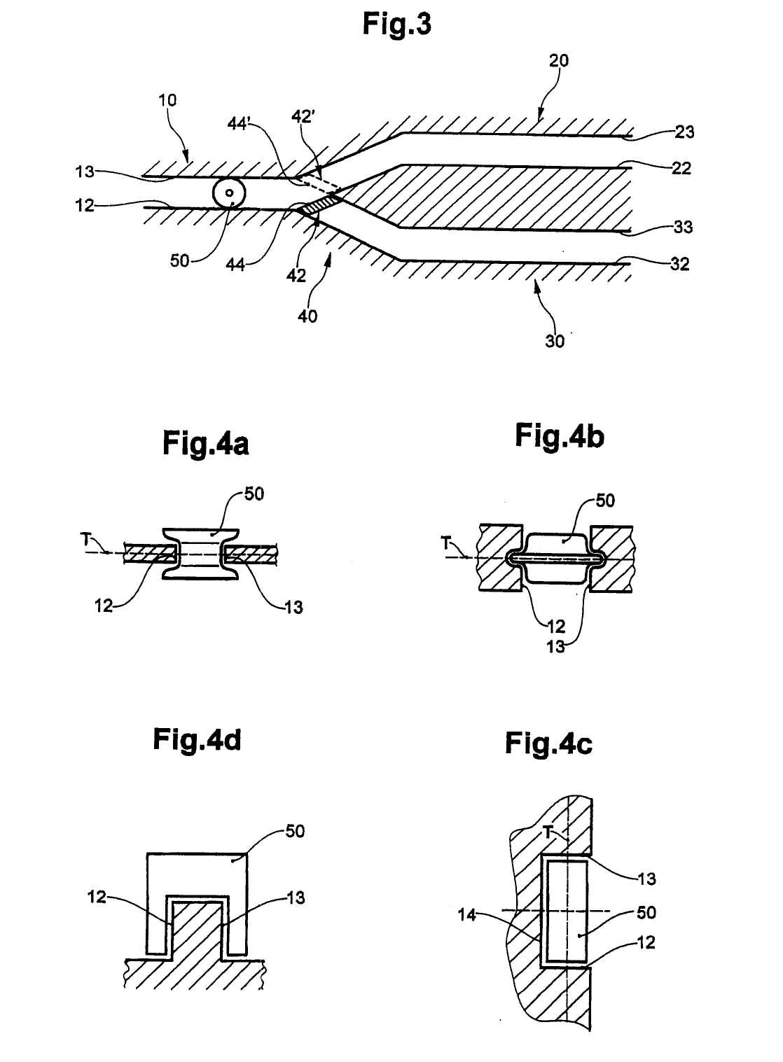

The displacement element 42, apart from the displacement element guide surface 44, has a further side wall 48, which in the active condition (FIG. 1b) is supported on the guide surface 12, 22 of the first and second guide section 10, 20. An additional stabilisation with regard to forces acting on the guide surface 44, is achieved by way of this rigid construction of the displacement element 42. In principle however, infinite shapes of the displacement element 42 are possible, as long as its guide surface 44 closes the gap (schematically shown in FIG. 2a+b, FIG. 3).

Indicated in FIG. 1b-d are two guide rods 65 running perpendicularly to the transport plane, as well as lateral guide elements 68 (FIG. 1c+d) which likewise serve for the stabilisation of the displacement element 42.

FIG. 2a+b show a modification of the diverter from FIG. 1a+b, with an actuation member 40 which comprises two actuation elements 42, 42′. The guide surface 12 of the first guide section 10 is distanced in the conveyor direction F1 to the guide surfaces 22, 32 of the second and of the third guides 20, 30, wherein the gap 100, 101 may be bridged in each case by way of one of the actuation elements 42, 42′. Again dashed is in each case the inactive position, in which the actuation element 42, 42′ does not come into contact with a guided object or does not deflect this, whereas the active position, in which the actuation element 42, 42′ deflects the guided object by way of guide surfaces 44, 44′, is represented with unbroken lines. The two actuation elements 42, 42′ are preferably movable in a counter-running manner. The movability of the lower actuation element 42 is above all of interest with a single-side guide, when a branching to three or more sections is to be created (a further guide section 30′ is indicated in FIG. 2b in a dashed manner).

FIG. 3 shows an example of a diverter whose guide sections 10, 20, 30 in each case comprise guide surfaces 12/13, 22/23, 32/33 which serve for the double-sided guiding of an object. “Double-sided guiding” is also to be understood as including the case with which an object is guided sometimes by the one and sometimes by the other guide surface. Inasmuch as this is concerned, a mere limitation surface is also a guide surface in the context of the invention.

The guide surface 13 of the first guide section 10 which is at the top in the representation, merges into the upper guide surface 23 of the second guide section 20, whereas a gap exists between the respective lower guide surfaces 12, 22. Accordingly, the lower guide surface 12 of the first guide section 10 merges into the lower guide surface 32 of the third guide section 30. Here too, a gap exists between the respective upper guide surfaces 13, 33. The upper or the lower gap may be selectively closed by way of a first and second displacement element 42, 42′ with a displacement guide surface 44 and 44′ respectively, which may be connected to the guide surfaces in a shoulderless manner. The displacement elements 42, 42′ are movable perpendicularly to the transport plane (representation plane) as in the examples above. Preferably, by way of an alternating drive, it is ensured that always exactly one displacement element 42, 42′ is located in the active position.

Possible profile shapes for the guide sections 10, 20, 30 with a guiding on both sides, is shown in FIG. 4a-d. FIG. 4a shows a slot-like profile with two guide surfaces 12, 13 which are parallel to one another. FIG. 4b shows a similar profile as FIG. 4a, but with a notch in the guide surface. FIG. 4c shows a box-like profile with two guide surfaces 12, 13 which are parallel to one another and with a base surface 14 lying in or parallel to the transport plane T, which is vertical here. FIG. 4d shows a profile which is inverse with regard to FIG. 4c.

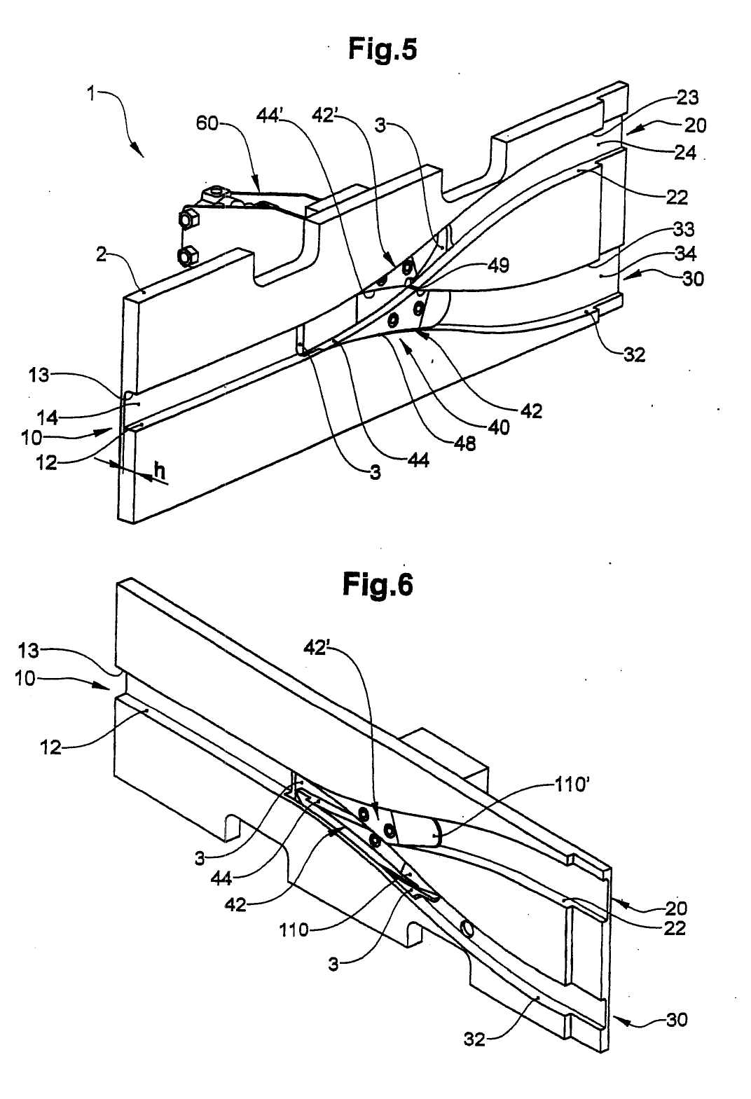

FIGS. 5 and 6 show a diverter 1 with the same basic construction as in FIG. 3, i.e. with a double-sided guide in the guide sections 10, 20, 30, in two different switch positions, and from two different perspectives. In FIG. 5, a connection between the first and the second guide section 10, 20 which is continuous with regard to the guide surfaces 12/13, 22/23, 32/33, is represented. FIG. 6 shows the reverse case, with a continuous connection between the first and the third guide section 10, 30.

The guide sections 10, 20, 30 are notched with a rectangular profile corresponding to FIG. 4c, into a plate-like base body 2. The base body 2 in the region of the branching of the guide sections 10, 20, 30 has a recess 3 in the base surfaces 14, 24, 34 as well as partly in the guide surfaces 23, 32, which, seen from the branching region of the diverter, lie radially to the outside. The displacement elements 42, 42′ of a displacement means 40 assembled on the rear side of the base body 2 may project through this recess 3, at least with their guide surfaces 44, 44′ into the guide sections 10, 20, 30.

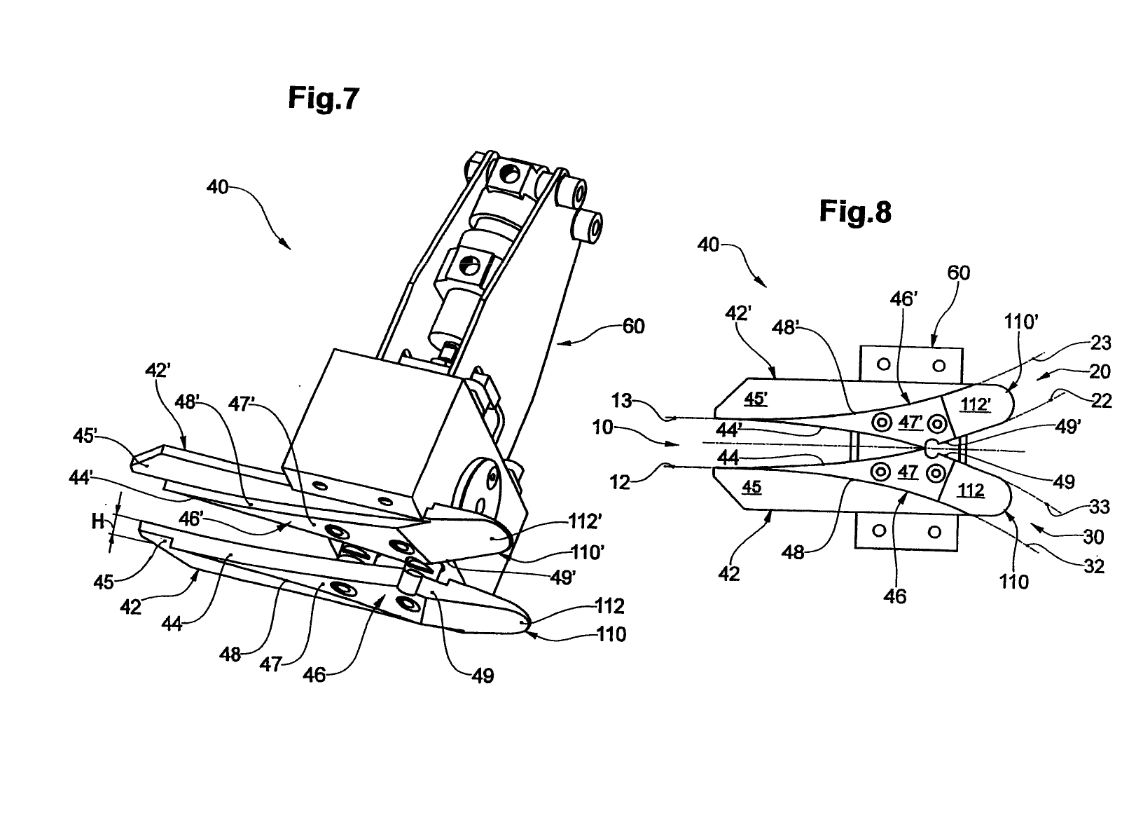

The displacement means 40 represented in more detail in the FIGS. 7 and 8, comprises two displacement elements 42, 42′ which are arranged essentially parallel to one another and are mirror-symmetrical to one another, as well as a drive 60, with which these may be displaced perpendicularly to the base body 2. The drive 60, for example, comprises a linear motor, which moves the e.g. mechanically coupled displacement elements 42, 42′ in opposite directions. Alternatively, a linear motor may be present for each displacement element, wherein a coupling is not necessary.

The displacement elements 42, 42′ consists of a base element 46, 46′ which is triangular to rectangular in a plan view of the transport plane, with a constant height H perpendicular to the transport plane. The inner lying side surfaces orientated to the respective other displacement element 42, 42′, serve as displacement element guide surfaces 44, 44′ and in the active position are flush with the guide surfaces of the guide sections which are to be connected (see e.g. surfaces 12, 44 and 22 in FIG. 5). The displacement element guide surfaces 44, 44′ enclose an acute angle with further side surfaces 48, 48′. These further side surfaces 48, 48′ in the active position run parallel to the guide surfaces 23, 32, which, seen from the branching region of the diverter, lie radially to the outside (see FIG. 8). By way of this, the displacement element 42, 42′ is guided perpendicularly to the transport plane and is stabilised with respect to transverse movements. A soft transition from the guide surfaces 12, 13 of the first guide section 10 onto the respective displacement guide surface 44, 44′ is realised by way of the acute angle of approx. 5-30°.

A front surface 47, 47′ of the base element 46, 46′ is plane and in the inactive condition lies in the plane of the base surfaces 14, 24, 34 or displaced to the rear with respect to these. They are located at the same level as the front surface of the base body 2, in the active condition.

Yet a further side wall 49, 49′ connects to the displacement element guide surfaces 44, 44′, which in the active position runs parallel to the guide surfaces 22, 23 which seen from the branching region of the diverter lie radially inwards (see FIG. 8), and likewise has a support function.

The side walls 48, 48′ merge into edges 45, 45′ running parallel to the transport plane. Here, these have an essentially triangular basic shape and a constant height, wherein the basic shape may also be different. The edges 45, 45′ in the inactive as well as in the active position of the respective displacement element 42, 42′ are located behind the base body 2, and serve for supporting the displacement element in a surfaced manner on the rear side of the base body 2.

In FIG. 8 in a plan view of the transport plane, one illustrates that the side walls at least of the base element 46, 46′ are flush with the guide surfaces of the guide sections 10, 20, 30. The respective inwardly orientated side walls 44, 44′ serve as displacement element guide surfaces and in the active position are flush with the guide sections which are to be connected (see e.g. surfaces 12, 44 and 22 in FIG. 5). The respective outwardly orientated side walls 48, 48′ have the same course as the respectively outwardly lying guide surfaces 13/23, 12/22 and are supported on this in the active condition. A further side surface 49, 49′ runs parallel to the inner lying guide surface 22, 33 of the second and of the third guide section 20, 30 respectively, and is likewise supported on this in the active condition.

A ramp 110, 110′ with a ramp surface 112, 112′ dropping obliquely from the height H, is formed on the base element 46, 46′. The ramp 110, 110′ in the active condition is arranged in the second and third guide section 20, 30. It serves for the self-activation of a change from the active into the inactive position by way of an object moved towards the actuation element 42, 42′ in the second or third guide means section 20, 30. If such is moved against the ramp 110, 110′, it produces a force component in the displacement direction, i.e. perpendicularly to the transport plane. The drive 60 for self-activation is preferably designed such that this force component is already sufficient, in order to activate the position change into the inactive condition and simultaneously also the position change of the respective other actuation element 42, 42′.

As a whole, the displacement element 42, 42′ may be introduced from the rear into the recess 3 by way of the described shape of the base element 46, 46′. In this manner, the displacement element 42, 42′ is stabilised with regard to tilting and shifting. An additional stabilisation is effected by way of the edge 45, 45′ which projects from the base element 46, 46′ in the manner of a flange and which bears on the rear side in the active position. The ramp 47, 47′ likewise joins into the guide sections 20, in a manner which is likewise exactly fitting, and forms an essentially continuous transition to its base surfaces 24, 34.

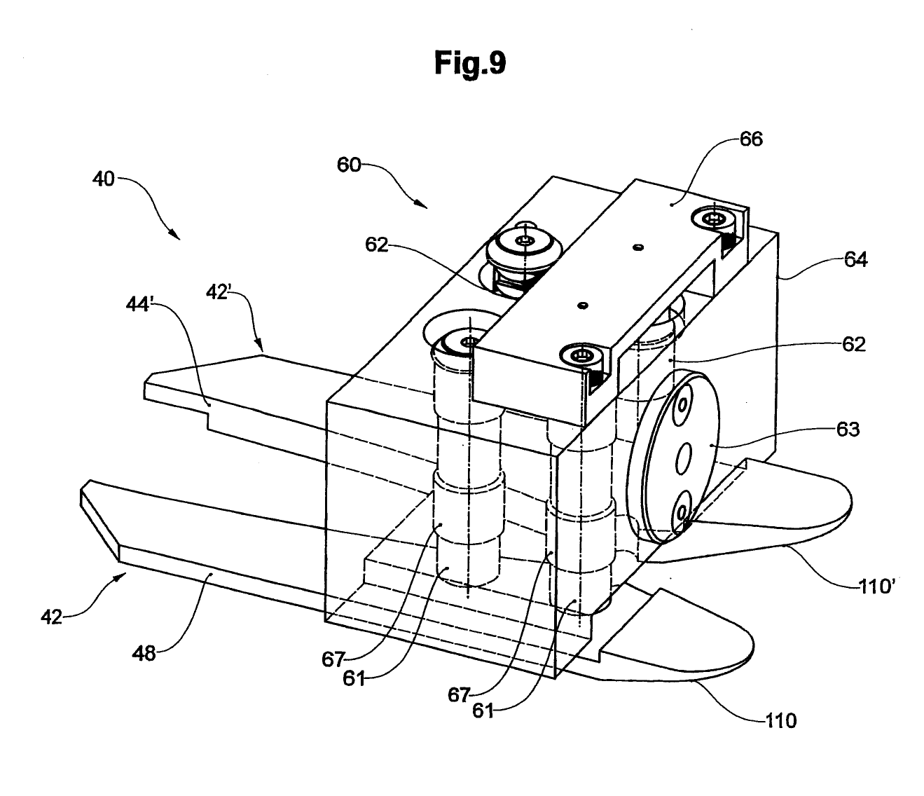

FIG. 9 schematically shows a purely passive drive 60 for switching the actuation elements 42, 42′ with a self-activation, e.g. by way of the object 50. The actuation elements 42, 42′ are in each case connected to two threaded rods 61, 62, which are mounted in a housing and are guided by guide cylinders 67. The displacement direction perpendicular to its axis is set in a stable manner by way of the threaded rods 61, 62. The threaded rods 61, 62 are coupled by way of a coupling element 63, e.g. a toothed wheel or a rack. By way of this, the threaded rods 61, 62, 61, 62 are moved in opposite directions, or a downwards movement of a rod pair caused by moving onto the ram is translated into an upwards movement of the other rod pair. It is particularly the case with the self-activation, that a fixation or stabilisation of the end positions of the threaded rods 61, 62 or the actuation elements 42, 42′ by way of magnets is advantageous.

For the active switching of the diverter, also with the variant of FIG. 9, one may apply an active drive element, which drives the coupling element 63 or at least one of the threaded rods 61, 62 in an externally controlled manner, e.g. a pneumatic cylinder.

Instead of a coupling of the actuation elements 42, 42′ with linear threaded rods, one way, for example, also provide a coupling by way of a rocker or a coupling carried out in a purely control-technological manner.

Instead of a mechanical self-activation, one may also provide a self-activation of the switch procedure by way of suitable sensors which cooperate with the moved objects, e.g. a light barrier or a bar code reader, whose output signal controls the drive.

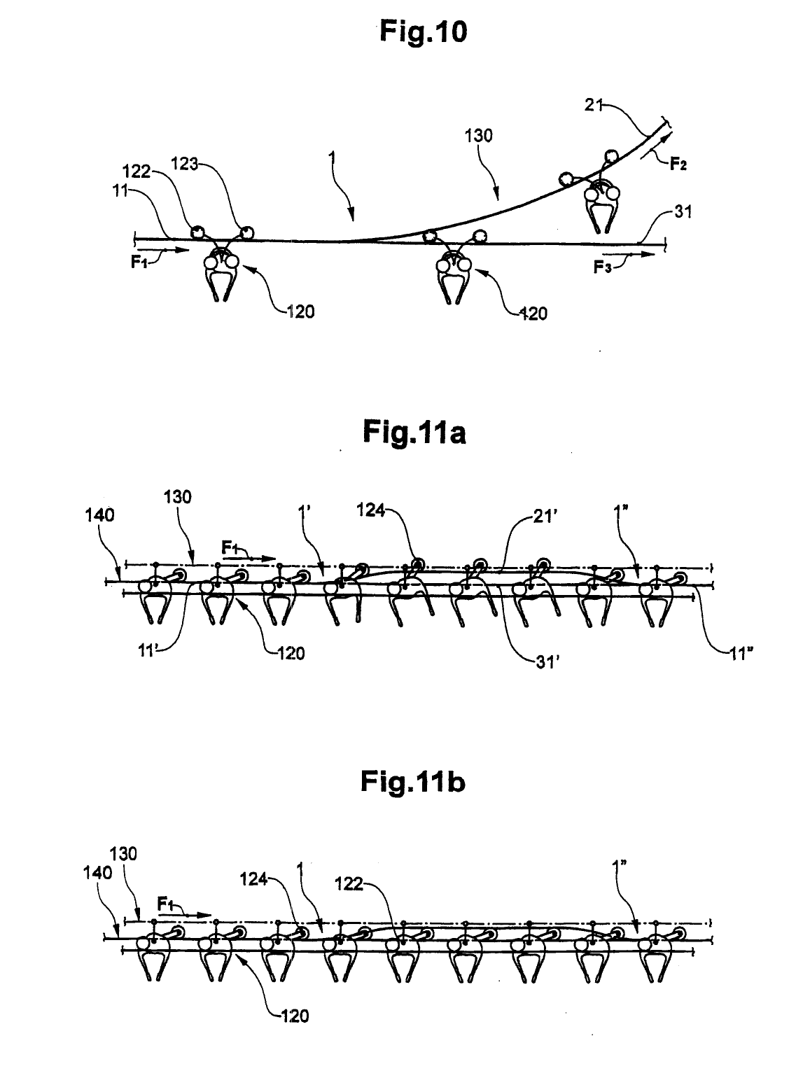

FIG. 10 shows an example for a conveyor system with a branching conveyor path 130 with several individual conveyor units 120 in the form of grippers. The conveyor path 130 comprises guides 11, 21, 31 which are connected by way of a diverter 1 according to the invention. The guides 11, 21, 31 here act with runner rollers 122, 123 of the conveyor unit 120. By way of the diverter 1, the conveyor units 120 which are originally moved in a first conveyor direction F1 along the first guide 11 may be selectively deflected into a direction F2 or F3 to the second or third guides 21, 31. The conveyor system may also be operated in the reverse direction, in order to lead together the conveyor units 120 coming from the second and third guides 21, 31, in the first guide 11.

The conveyor units 120 may also be a closed together into an interconnection, wherein the complete interconnection is deflected by way of the diverter 1.

FIG. 11a+b show an example of a conveyor system, with which it is not the conveyor path 130 for the conveyor unit 120 itself which comprises the branching, but a control cam 140. The control cam 140 here comprises guides 11′, 21′, 31′, 11″, which cooperate with control elements 124 of the conveyor unit 120 and lead these. Here, the conveyor units 120 are represented by way of example as grippers.

In the example of FIG. 11a, the diverter 1′ is switched such that the control elements 124 of the conveyor units 120 moved in the first conveyor direction F1 are deflected from a first guide 11′ to a second guide 21′. Since the second guide 21′ has a different distance to the conveyor path 130 than the first guide 11′, the orientation of the control element 124 relative to the conveyor unit 120 changes. Here, the grippers are opened by way of this. Further additional functions such as pivoting may likewise be controlled with such control elements 124.

The diverter 1′ is switched in FIG. 11b, such that the control elements 124 are led to a third guide 31′, which has an unchanged distance to the conveyor path 130 and thus the orientation of the control elements 124 relative to the conveyor units 120 does not change. The grippers are accordingly not opened.

A further diverter 1″ conveys the second and third guides 21′, 31′ into a further guide 1″, which again has the original distance to the conveyor path 130 and—in the case of FIG. 11a—again creates the initial orientation of the control element 124 relative to the conveyor units 120. The grippers are thus closed inasmuch as they were opened. The further diverter 1″ is preferably self-activating.

It is also possible to lead the control elements 124 to successive conveyor units 120 in an alternating manner or in any sequence via one of the two alternative guide paths of the control cam 140, in order in a targeted manner, with the individual conveyor units 120, to activate addition functions, e.g. opening each second gripper.

The conveyor units such as grippers, pockets, support elements may in each case comprise two or more runner rollers or control elements, which are guided in a common system of guides or also in two or more systems of guides, which are separate from one another. For example, the conveyor units may in each case comprise two runner rollers, which are distanced to one another transversely to the conveyor direction, e.g. for the double-sided support and accommodation of the weight force of the conveyor units. The guides which are required with this are arranged in two systems which are separate from one another, in two planes which are parallel to one another and which are distanced transversely to the conveyor direction. Each of these systems may be equipped with diverters according to the invention.

1. A diverter (1) for the selective connection of three guides for the guided movement of at least one control element or of at least one runner roller of a conveyor unit, comprising:
a first, a second and a third guide section (10, 20, 30) with in each case at least one guide surface (12, 13, 22, 23, 32, 33) which is capable of guiding the control element or the runner roller, as well as an actuation member (40) which may assume at least two positions,
wherein at least one guide surface (12, 13) of the first guide section (10), whilst forming a gap (100), is distanced from a guide surface (32, 33) of the third guide section (10),
wherein the actuation member (40) comprises at least one actuation element (42, 42′) which may be moved essentially perpendicularly to the transport plane (T) defined by the guide sections (10, 20, 30), between a first position and a second position,
wherein an at least largely uninterrupted connection between at least one guide surface (12, 13, 22, 23) of the first and second guide (10, 20, 30) exists in the first position, and
wherein an at least largely uninterrupted connection between at least one guide surface (12, 13, 32, 33) of the first and the third guide section (10, 20, 30) exists in the second position.

2. A diverter (1) according to claim 1, wherein the at least one guide surface (12, 13, 22, 23, 32, 33) of the guide sections (10, 20, 30) is oriented essentially perpendicular to the transport plane (T).

3. A diverter (1) according to claim 2, wherein the actuation member (40) comprises at least one actuation element (42, 42′), which in each case has an actuation element guide surface (44, 44′) which is orientated perpendicularly to the transport plane (T) and which, in the first position, is located between the guide surfaces (12, 13, 22, 23, 32, 33) of the assigned guide sections (10, 20, 30) in a manner such that these merge into one another in a preferably shoulderless manner, and in the second position are distanced from the guide surfaces (12, 13, 22, 23, 32, 33) in a manner such that in the case of application, objects (50) guided in the guide sections (10, 20, 30) are uninfluenced by the actuation element guide surface (44, 44′).

4. A diverter (1) according to claim 3, wherein at least one of the positions of the actuation element (42, 42′) is stabilised in a magnetic manner.

5. A diverter (1) according to one of the preceding claims, claim 3, further comprising a drive (6) for moving the at least one actuation element (42, 42′).

6. A diverter (1) according to claim 1, wherein the actuation member (40) comprises two actuation elements (42, 42′), which are movable in opposite directions perpendicularly to the transport plane (T), wherein the first actuation element (42) is capable of creating an at least largely uninterrupted connection between the guide surfaces (12, 13, 32, 33) of the first and of the third guide section (10, 30), and the second actuation element (42′) is capable of creating an at least largely uninterrupted connection between the guide surfaces (12, 13, 22, 23) of the first and of the second guide section (10, 20).

7. A diverter (1) according to claim 6, further comprising an active or passive drive (60) for moving the actuation elements (42, 42′) in an opposite directional manner.

8. A diverter (1) according to claim 7, wherein the drive (60) comprises two threaded rods (61, 62) which are arranged parallel to one another and are coupled in the opposite directional sense by way of a coupling element (63), on whose end an actuation element (42, 42′) is arranged in each case.

9. A diverter (1) according to claim 6, wherein the guide sections (10, 20, 30) in each case comprise two guide surfaces (12, 13, 22, 23, 32, 33) which are arranged essentially perpendicularly to the transport plane (T).

10. A diverter (1) according to claim 1, wherein the at least one actuation element (42, 42′) comprises a ramp (47, 47′) which is inclined with respect to the transport plane (T), wherein the ramp (47, 47′) is capable of cooperating with objects (50) guided in the second or third guide mean section (20, 30), in a manner such that a force component perpendicular to the transport plane (T) is produced by the moving of such an object (50) onto the ramp (47, 47′), said force component effecting a positional change of the actuation element (42, 42′).

11. A conveyor system, with conveyor units (120) which may be moved along a conveyor path (130), wherein the conveyor path (130) comprises a plurality of guides (11, 21, 31), as well as at least one diverter (1) according to claim 1.

12. A conveyor system, with conveyor units (120), which may be moved along a conveyor path (130), and with a control cam (140) which is arranged at least in regions along the conveyor path (130) and which is capable of cooperating with a control element (124) of the conveyor unit (120) for the control of an addition function of the conveyor unit (120), wherein the control cam (140) comprises a plurality of guides (11′, 21′ 31′, 11″) as well as at least one diverter (1′, 1″) according to claim 1.

13. The use of a diverter according to claim 1 for manufacturing a control cam (140) for a gripper conveyor, pocket conveyor or support conveyor.

14. An assembly, consisting of at least one actuation element as well as a drive for moving the actuation element, for creating a diverter according to claim 1.

15. An assembly according to claim 14, wherein the at least one actuation element comprises a guide surface which is movable perpendicularly to its surface normal by way of the drive.
